(19) United States
(12) Patent Application Publication
(10) Pub. No.: US 2011/0055253 A1
(43) Pub. Date: Mar. 3, 2011

(54) Apparatus and methods for integrated management of spatial/geographic contents

(75) Inventors: Jae-Jun Yoo, Daejeon (KR); Seong-Ho Lee, Daejeon (KR); Jae-Chul Kim, Daejeon (KR); Yoon-Seop Chang, Daejeon (KR); Sun-Rae Park, Daejeon (KR)

(73) Assignee: ELECTRONICS AND TELECOMMUNICATIONS RESEARCH INSTITUTE, Daejeon-city (KR)

(21) Appl. No.: 12/805,606

(22) Filed: Aug. 9, 2010

(30) Foreign Application Priority Data
Aug. 26, 2009 (KR) 10-2009-0079460
Jan. 28, 2010 (KR) 10-2010-0007991

(51) Int. Cl. G06F 17/30

(52) U.S. Cl. 707/769; 707/812; 707/E17.014

(57) ABSTRACT

Disclosed is an apparatus and method for integrated management of spatial/geographic contents that detects spatial information from contents including spatial semantics and integrates and manages the contents in various types. The apparatus for integrated management of spatial/geographic contents includes: a storage unit that divides and stores a plurality of contents according to types of contents and stores identifiers and representative spatial information of each of the plurality of contents; an extracting unit that extracts input search information and the representative spatial information from the contents; and a managing unit that detects identifiers corresponding to the representative spatial information extracted from the search information in the extracting unit from the storage unit and detects the contents corresponding to the detected identifiers from the storage unit.

### CROSS REFERENCE TO RELATED APPLICATIONS

This application claims priority to Korean Patent Application No. 10-2009-0079460 filed on Aug. 26, 2009 and Korean Patent Application No. 10-2010-0007991 filed on Jan. 28, 2010, the entire contents of which are herein incorporated by reference.

### BACKGROUND OF THE INVENTION

1. Field of the Invention

The present invention an apparatus and method for integrated management of spatial/geographic contents, and more specifically, to an apparatus and method for integrated management of spatial/geographic contents for effectively integrating and managing various types of spatial/geographic contents such as 2D or 3D digital maps and satellite images, spatial pictures and images, spatial moving pictures, web pages (or documents) and sound including spatial semantics, etc.

2. Description of the Related Art

With the development of information technology and the spread of application thereof, semantics of the existing spatial information such as 2D or 3D digital maps and satellite picture information, etc. is changed into contents having more various types and a demand for technologies and services thereof is also diversified, such that a need to more effectively integrate and manage them is being increased. For example, as Internet and web technologies are quickly developed, camera photos of specific places and web pages (documents) describing specific provinces, etc., which are not treated as the spatial information also have location attribution, such that they are gradually incorporated into the category of the spatial information. The semantics expansion and diversity of the spatial information create a demand for technologies capable of accessing and processing contents having entirely different types using a single consistent structure and method.

However, since the current technology manages the contents having various types as separate contents and does not provide unified view (viewpoint, view) thereof, there is a problem in that it has a limited range in processing them and developing and creating new services using them.

### SUMMARY OF THE INVENTION

The present invention proposes to solve the above problems. It is an object of the present invention to provide an apparatus and method for integrated management of spatial/geographic contents to integrate and manage various types of contents by detecting spatial information from contents including spatial semantics.

In order to achieve the above object, an apparatus for integrated management of spatial/geographic contents according to an embodiment of the present invention includes: a storage unit that divides and stores a plurality of spatial/geographic contents according to types of contents and stores identifiers and representative spatial information of each of the plurality of spatial/geographic contents; an extracting unit that extracts the representative spatial information from input search information and the spatial/geographic contents; and a managing unit that detects identifiers corresponding to the representative spatial information extracted from the search information in the extracting unit from the storage unit and detects the spatial/geographic contents corresponding to the detected identifiers from the storage unit.

The managing unit sets the identifiers according to the types of the spatial/geographic contents.

The storage unit associates the spatial/geographic contents with the identifiers set in the managing unit and stores them.

The storage unit associates the representative spatial information extracted from the spatial/geographic contents in the extracting unit with the identifiers set in the spatial/geographic contents in the managing unit and stores them.

The storage unit includes: a satellite information storage unit that stores the satellite picture spatial information; a web page storage unit that stores spatial web pages; a picture storage unit that stores the spatial picture and the spatial moving pictures; a sound storage unit that stores spatial sound; and a spatial information storage unit that associates the identifiers and representative spatial information of the spatial/geographic contents and stores them.

The extracting unit sets the representative spatial/geographic information of the corresponding spatial/geographic contents based on the spatial information and the geographical information of keywards extracted from the spatial/geographic contents.

The extracting unit sets the storage location of the spatial/geographic contents as the representative spatial information of the spatial/geographic contents.

The extracting unit includes: a web page spatial information extracting module that extracts the representative spatial information from the spatial web pages; a picture spatial information extracting module that extracts the representative spatial information from the spatial pictures; a moving picture spatial information extracting module that extracts the representative spatial information from the spatial moving picture file; and a sound spatial information extracting module that extracts the representative spatial information from the spatial sound files.

The apparatus for integrated management of spatial/geographic contents further includes an input unit that receives at least one of the search information and the spatial/geographic contents.

The managing unit detects the identifiers corresponding to the representative spatial information included in the search information from the storage unit when the search information including the representative spatial information of the spatial/geographic contents is input through the input unit.

The managing unit detects the spatial/geographic contents corresponding to the identifiers included in the search information from the storage unit when the search information including the identifiers of the spatial/geographic contents is input.

In order to achieve the above object, a method for integrated management of spatial/geographic contents according to an embodiment of the present invention includes: setting identifiers of spatial/geographic contents by a managing unit; extracting representative spatial information from the spatial/geographic contents by an extracting unit; spatial information storing that associates the identifiers of the spatial/geographic contents set at the setting step with the representative spatial information of the spatial/geographic contents extracted at the extracting step by the managing unit and stores them in the storage unit; and contents storing that associates the identifiers set at the setting step with the spatial/geographic contents by the managing unit and stores them in the storage unit.

The setting sets the identifiers according to the type of the spatial/geographic contents by the managing unit.

The contents storing classifies the contents for the types of contents by the managing unit and stores the spatial/geographic contents in the storage unit.

The extracting sets the representative spatial information of the corresponding spatial/geographic contents based on the spatial information and the geographical information of the keywords extracted from the spatial/geographic contents by the extracting unit.

The method for integrated management of spatial/geographic contents further includes receiving the spatial/geographic contents by the input unit.

In order to achieve the above object, a method for searching spatial/geographic contents in a method for integrated management of spatial/geographic contents according to an embodiment of the present invention includes: extracting representative spatial information from input search information by an extracting unit; identifier detecting that detects identifiers corresponding to the representative spatial information extracted in the extracting step from the storage unit, by the managing unit; and contents detecting that detects the spatial/geographic contents corresponding to the identifiers detected in the identifier detecting step from the storage unit, by the managing unit.

The method for searching spatial/geographic contents further includes inputting the search information for searching the contents from a user by the input unit.

The identifier detecting detects the identifiers corresponding to the representative spatial information included in the search information from the storage unit when the search information including the representative spatial information of the spatial/geographic contents is input at the inputting step.

The contents detecting detects the spatial/geographic contents corresponding to the identifiers included in the search information from the storage unit by the managing unit when the search information including the identifiers of the spatial/geographic contents is input at the inputting step.

According to the present invention, the apparatus and method for integrated management of spatial/geographic contents proposes the technology capable of viewing various types of contents including the spatial semantics from an integrated viewpoint to effectively integrate and manage various spatial/geographic contents, thereby making it possible to more effectively search the spatial/geographic contents that are separately managed according to the type and are hard to search due to the correlation therebetween.

Further, the apparatus and method for integrated management of spatial/geographic contents can expand the target and range of the existing general search services. For example, when generally searching the web pages including only the specific keywords, the pictures or the sound spatially associated with the web pages can be searched together.

### BRIEF DESCRIPTION OF THE DRAWINGS

FIG. 1 is a diagram for explaining spatial/geographic contents;

FIG. 2 is a block diagram for explaining an apparatus for integrated management of spatial/geographic contents according to an embodiment of the present invention;

FIG. 3 is a diagram for explaining a storage unit of FIG. 2;

FIG. 4 is a diagram for explaining an extracting unit of FIG. 2;

FIG. 5 is a diagram for explaining a managing unit of FIG. 2;

FIG. 6 is a diagram for explaining a modified example of an apparatus for integrated management of spatial/geographic contents according to an embodiment of the present invention;

FIG. 7 is a flow chart for explaining a method for registering spatial/geographic contents according to the method for integrated management of spatial/geographic contents according to the embodiment of the present invention;

FIGS. 8 and 9 are flow charts for explaining a method for searching spatial/geographic contents according to the method for integrated management of spatial/geographic contents according to the embodiment of the present invention;

FIGS. 10 to 12 are flow charts for explaining a method for extracting representative spatial information from a spatial web page;

FIGS. 13 to 15 are flow charts for explaining the method for extracting representative spatial information from spatial pictures;

FIG. 16 is a flow chart for explaining the method for extracting representative spatial information from spatial moving pictures; and

FIGS. 17 and 18 are flow charts for explaining the method for extracting representative spatial information from spatial sound.

### DETAILED DESCRIPTION OF THE PREFERRED EMBODIMENTS

Hereinafter, most preferred embodiments of the present invention will be described in detail with reference to the accompanying drawings so that those skilled in the art may easily implement the spirit of the present invention. First of all, we should note that in giving reference numerals to elements of each drawing, like reference numerals refer to like elements even though like elements are shown in different drawings. Further, in describing the present invention, well-known functions or constructions will not be described in detail since they may unnecessarily obscure the understanding of the present invention.

First, terms used for detailed description of an apparatus and method for integrated management of spatial/geographic contents according to an embodiment of the present invention are defined as follows.

Satellite picture spatial information means information obtained by using 2D or 3D digital maps and satellite pictures, etc. At this time, the satellite picture spatial information, which is spatial information including geographical location information such as latitude, longitude, etc., means typical data (information) that is called the spatial information in the related art.

The spatial web page means web pages and documents including spatial semantics and attributes. For example, there may be the web page for tourist guide describing “Jeju Island” that is a representative tourist resort of Korea, the web page for guiding the City Hall of Seoul that introduces “the City Hall of Seoul” having the spatial location information, etc.

The spatial picture means still pictures and images including the spatial semantics and attributes. For example, there may be camera photos taking “the City Hall of Seoul”, still pictures (for example, street views of maps services provided from Internet portal sites) taken by travelling vehicles attached with a camera, etc.

The spatial moving pictures mean the moving pictures including the spatial semantics and attributes. For example, there may be moving pictures obtained by continuously photographing specific roads in Seoul, etc.

The spatial sound means sound (voice) including the spatial semantics and attributes. For example, there may be wind sound, the sound of birds, etc., that are recorded in “Okcheon, Chungbuk” province.

The spatial/geographic contents are a generic term for various types of contents such as satellite picture spatial information, spatial pictures, spatial moving pictures, spatial sound, etc., that include the spatial semantics attributes. The spatial/geographic contents may include additional data such as mobile users or moving locations of vehicles in addition to contents such as the satellite picture spatial information, the spatial pictures, the spatial moving pictures, the spatial sound, etc. In order to more clearly and specifically describe the main gist of the present invention, the above-mentioned spatial/geographic contents will be mainly described below.

The representative spatial information means the representative geographical spatial information (digital information) extracted from the spatial/geographic contents. At this time, the semantics of the representative spatial information can be changed according to the definition of the system. For example, when the representative spatial information is defined to be the spatial location including each spatial/geographic content, the representative spatial information of the spatial web pages (documents) exemplified above may be the geographical locations of “Jeju Island” and “the City Hall of Seoul”, the representative spatial information of the spatial pictures exemplified above may be “the City Hall of Seoul” and geographical locations of roads obtained from pictures, the representative spatial information of the spatial moving pictures exemplified above may be geographical locations of “specific roads of Seoul”, and the representative spatial information of the spatial sound exemplified above may be geographical locations of “Okcheon, Chungbuk” province.

The representative spatial information may be the generated locations (semantics different from geographical locations described by spatial/geographic contents), locations including (storing) the corresponding spatial/geographic contents), etc. As described above, the semantics of the representative spatial information may be changed according to whether the system for integrated management of various spatial/geographic contents sees the common spatial attributes of these spatial/geographic contents as any semantics.

The search information is information input to search the spatial/geographic contents. The type of the search information to search the spatial/geographic contents may be largely classified into three examples. Of course, although there may be more types of search information, three types will be mainly described in consideration of the gist of the present invention.

First, there is a type of search information that does not use the representative spatial information at the time of the search of the spatial/geographic contents. In other words, there is the search information requesting the search of one type of spatial/geographic contents. For example, the search of the spatial web pages can use the search information, “search web pages (documents) including words called YY”. The search of the spatial pictures (that is, still pictures and images) can use the search information, “search images photographed by a person called UU”. The search of the spatial sound can use the search information, “search sound recorded by a person called UU”. The search information in the above-mentioned examples may not consider the spatial information (that is, representative spatial information) of each of the spatial/geographic contents.

Second, there is a type of search information that the representative spatial information for searching the spatial/geographic contents or the range of the representative spatial information is explicitly provided in the search information. That is, the type of search information is a type that can confirm and estimate the target of contents, that is, search results by explicitly giving the range of the representative spatial information to be referenced in the search information and first referencing the representative spatial information using the same. For example, the search information, “search area XX commonly describing all of the web pages (documents), images, moving pictures, sound, etc. or the search information, “search web pages (documents) or images including information on area XX”, or “search images and moving pictures including building called ZZ”, etc. can be considered to be the type of search information. When first referencing the representative spatial information, the relationship between several spatial/geographic contents can be more effectively analyzed and processed, compared with when obtaining the results by directly accessing the spatial/geographic contents.

Third, there is a type of search information that does not explicitly provide the representative spatial information for searching the spatial/geographic contents or the range of the representative spatial information in the search information. For example, the search information, “search images, moving pictures, and sound (voice) for an area describing web pages (documents) satisfying given conditions” can be used.

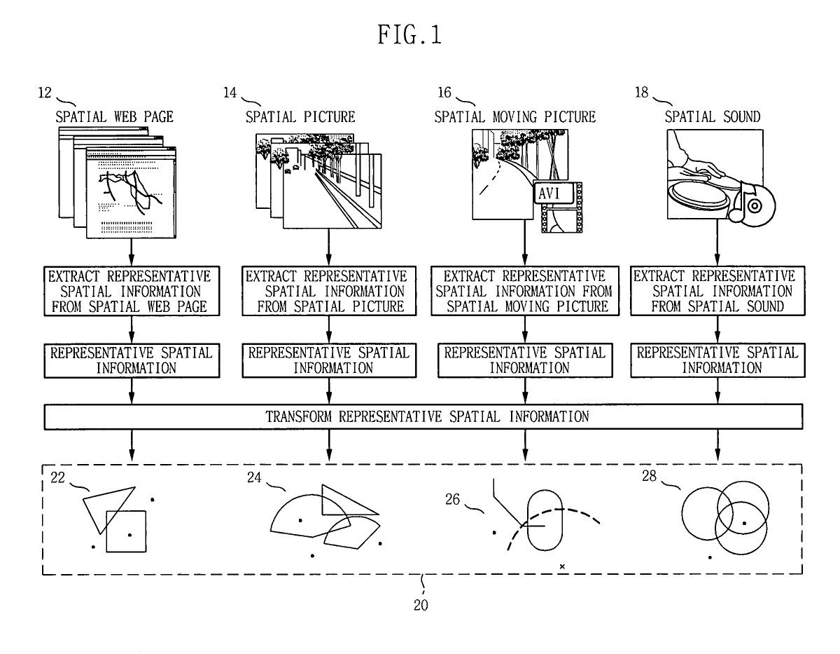

The gist and configuration of the present invention will be described below based on the described terms. FIG. 1 is a diagram for explaining spatial/graphic contents.

As shown in FIG. 1, the present invention relates to integrating and managing spatial/graphic contents 10; 12, 14, 16, and 18 in various forms. To this end, the present invention extracts spatial semantics (representative spatial information) from spatial/graphic contents 10 in various forms including spatial semantics and attributes and manages and processes them in an integrated form, thereby having a structure that can view the spatial/geographic contents 10 having no morphological similarity in terms of a common spatial semantics.

At this time, the representative spatial information extracted from the spatial/geographic contents 10 in various forms can be easily referenced each other or integrated and managed, such that it manages and processes the spatial/geographic contents 10 in various forms through one interface. The representative spatial information may be managed with different layers or an integrated layer according to the type of each spatial/geographic content 10 and the efficiency pursued by the system.

Further, the extracted representative spatial/geographic information may be transformed or abstracted into different information and types having more similar semantics (for example, transform the representative spatial information in a point or line shape into representative spatial information 20 in polygonal shapes 22, 24, 26, and 28.

Hereinafter, an apparatus for integrated management of spatial/geographic contents according to an embodiment of the present invention will be described in detail with reference to the accompanying drawings.

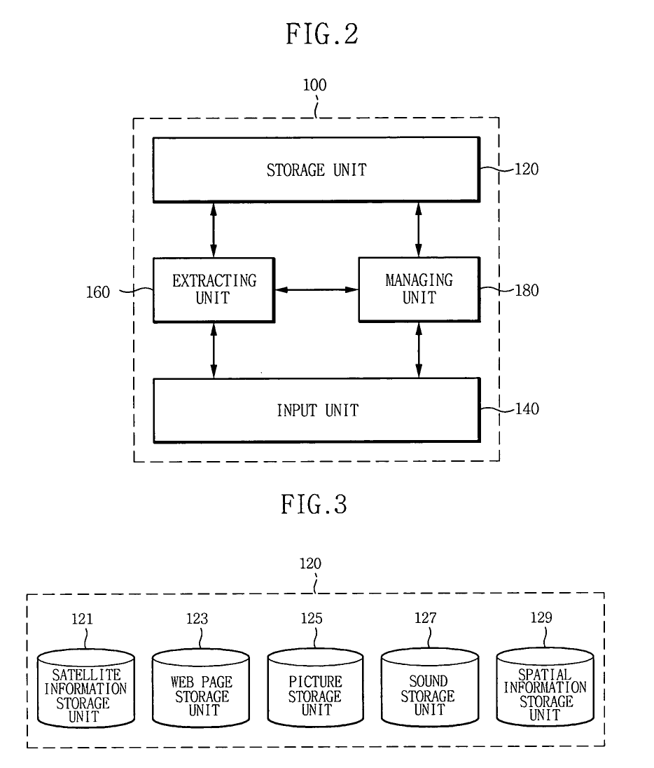

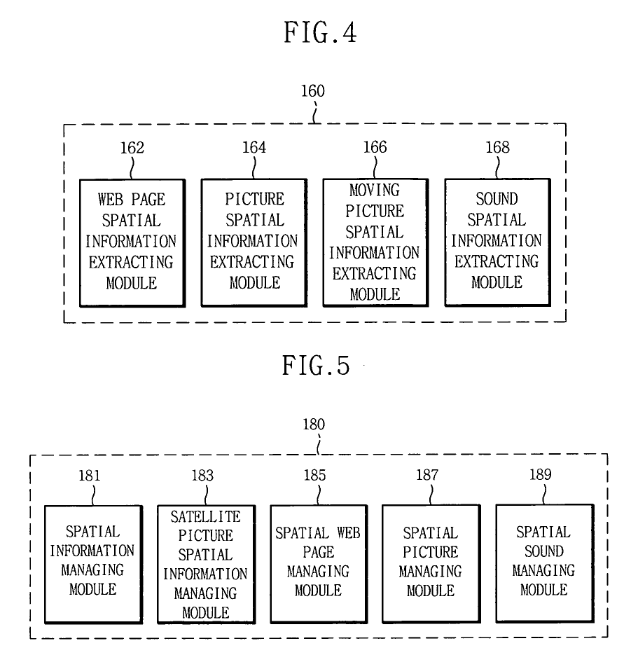

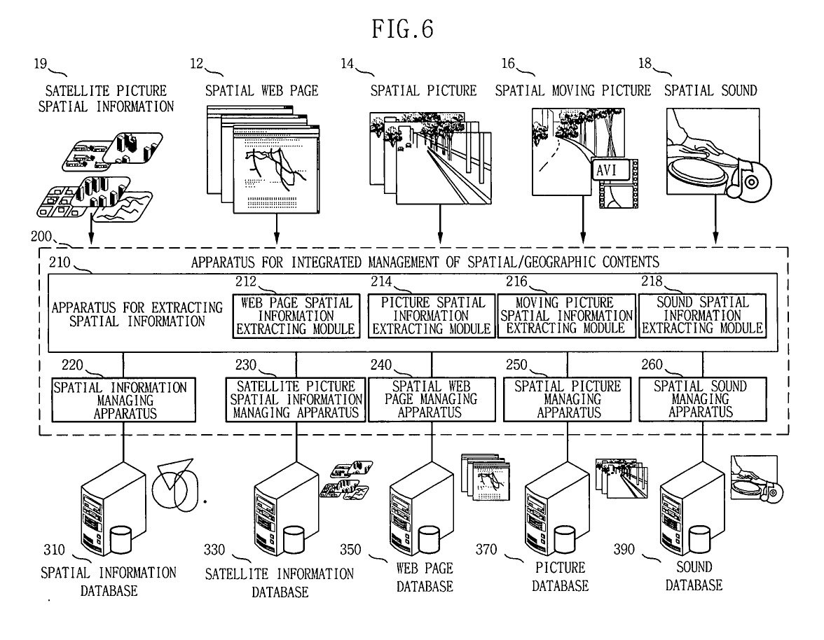

FIG. 2 is a block diagram for explaining an apparatus for integrated management of spatial/geographic contents according to an embodiment of the present invention, FIG. 3 is a diagram for explaining a storage unit of FIG. 2, FIG. 4 is a diagram for explaining an extracting unit of FIG. 2, and FIG. 5 is a diagram for explaining a managing unit of FIG. 2. FIG. 6 is a diagram for explaining a modified example of an apparatus for integrated management of spatial/geographic contents according to an embodiment of the present invention.

As shown in FIG. 2, an apparatus 100 for integrated management of spatial/graphic contents includes a storage unit 120, an input unit 140, an extracting unit 160, and a managing unit 180.

The storage unit 120 stores a plurality of spatial/graphic contents 10, identifiers set in each of the plurality of spatial/geographic contents 10, and representative spatial information set in each of the plurality of spatial/geographic contents. At this time, the storage unit 120 divides the plurality of spatial/geographic contents 10 according to a form (type) of contents and stores them. In other words, the storage unit 120 divides the plurality of spatial/geographic contents 10 into satellite picture spatial information 19, spatial web pages 12, spatial pictures 14 (that is, spatial images and spatial still pictures), spatial moving pictures 16, and spatial sound 18 and stores them. The storage unit 120 associates the spatial/geographic contents 10 with the identifiers of the corresponding spatial/geographic contents 10 and stores them. The storage unit 120 associates the representative spatial information and identifiers of the spatial/geographic contents 10 and stores them. To this end, as shown in FIG. 3, the storage unit 120 is configured to include a satellite information storage unit 121 that stores the satellite picture spatial information 19 including 2D or 3D satellite pictures, a web page storage unit 123 that stores the spatial web pages 12 including web pages or document files, etc., on Internet, a picture storage unit 125 that stores the spatial moving pictures 16 including the spatial pictures 14 including image files and still picture files and the spatial moving pictures 16 including moving picture files, a sound storage unit 127 that stores a spatial sound 18 configured of a sound file, and a spatial information storage unit 129 that associates the identifiers and representative spatial information of the spatial/geographic contents 10 and stores them.

The input unit 140 receives search information for searching the spatial/geographic contents 10. That is, the input unit 140 receives the search information from a user for searching the spatial/geographic contents 10. The input unit 140 is connected to a user terminal by a communicating unit that can exchange data and receives the search information from the user terminal. Of course, the user can directly input the search information in the apparatus 100 for integrated management of spatial/geographic contents. In this case, the input unit 140 includes an input device such as a keyboard, mouse, etc.

The input unit 140 receives the added spatial/geographic contents 10. In other words, the input unit 140 receives the spatial/geographic contents 10 to be added to the apparatus 100 for integrated management of spatial/geographic contents from a user, a manager, a provider, etc. At this time, the input unit 140 is connected to the user terminal, the manager terminal, and the provider terminal by the communication device that can exchange data, thereby receiving the added spatial/geographic contents 10. Of course, the input unit 140 may include a recognition unit (for example, CD-ROM, CD RW, etc.), which recognizes the spatial/geographic contents 10, from storage media (for example, CD, HDD, USB memory, etc.).

The extracting unit 160 extracts the representative spatial information from the input search information. In other words, the extracting unit 160 extracts the representative spatial information in the search information input in a query form from the user in order to search the spatial/geographic contents 10. At this time, the extracting unit 160 cannot perform the extraction of the representative spatial information according to the type of search information. That is, when the search information corresponding to the first and second types among the types of search information described in the description of the above-mentioned terms, the extraction of the representative spatial information is not performed. In other words, although the representative spatial information is described in the first and second types of search information, the representative spatial information is not used at the time of searching the spatial/geographic contents 10, such that the extracting unit 160 does not extract the representative spatial information from the search information. When the third type of search information is input, the extracting unit 160 extracts the representative spatial information from the web pages to search the spatial/geographic contents 10. That is, the extracting unit 160 detects the spatial information from the web pages described in the search information input by the user and sets it as the representative spatial information of the search information.

The extracting unit 160 extracts the representative spatial information from the spatial/geographic contents 10. In other words, the extracting unit 160 extracts the representative spatial information from the spatial/geographic contents 10 to register the added spatial/geographic contents 10. At this time, the extracting unit 160 sets the representative spatial information of the corresponding spatial/geographic contents 10 based on the spatial information and geographical information of the keyword extracted from the spatial/geographic contents 10. Of course, the representative spatial information can be set by various methods according to the types of the spatial/geographic contents 10. To this end, as shown in FIG. 4, the extracting unit 160 is configured to include a web page spatial information extracting module 162 that extracts the representative spatial information from the spatial web pages 12, a picture spatial information extracting module 164 that extracts the representative spatial information from the spatial pictures 14, a moving picture spatial information extracting module 166 that extracts the representative spatial information from the files of the spatial moving pictures 16, and a sound spatial information extracting module 168 that extracts the representative spatial information from the files of the spatial sound 18.

The managing unit 180 searches the spatial/geographic contents 10 according to the user request and provides them to the corresponding user. The managing unit 180 detects the identifiers corresponding to the representative spatial information from the storage unit 120 when the search information is input from the user, the representative spatial information being extracted from the search information in the extracting unit 160. In order words, the managing unit 180 detects the identifiers associated with the representative spatial information from the spatial information storage unit 129, the representative spatial information being extracted from the extracting unit 160. At this time, the managing unit 180 generates an identifier list that detects one or more identifiers associated with the representative spatial information extracted from the spatial information storage unit 129.

The managing unit 180 detects the spatial/geographic contents 10 corresponding to the detected identifiers from the storage unit 120. In other words, the managing unit 180 detects the spatial/geographic contents 10 associated with the identifiers included in the generated identifier list. At this time, the managing unit 180 classifies the identifiers included in the identifier list according to type (that is, the type of contents) and detects the spatial/geographic contents 10 associated with the identifiers from the storage unit 120 (that is, the satellite information storage unit 121, the web page storage unit 123, the picture storage unit 125, the sound storage unit 127).

The managing unit 180 detects the identifiers corresponding to the representative spatial information included in the search information from the storage unit 120 when the search information including the representative spatial information of the spatial/geographic contents 10 is input through the input unit 140. In other words, the managing unit 180 generates the identifier list if the search information includes the representative spatial information. And the managing unit 180 detects the spatial/geographic contents 10 associated with the identifiers included in the generated identifier list. In this case, the above-mentioned extracting unit 160 does not extract the representative spatial information from the search information.

The managing unit 180 detects the spatial/geographic contents 10 corresponding to the identifiers included in the search information from the storage unit 120 when the search information including the identifiers of the spatial/geographic contents 10 is input to the input unit 140. In other words, when the identifiers are included in the search information, the managing unit 180 does not generate the identifier list and detects the spatial/geographic contents 10 associated with the identifiers included in the search information from the storage unit 120. In this case, the above-mentioned extracting unit 160 does not extract the representative spatial information from the search information.

The managing unit 180 detects the spatial/geographic contents 10 from the storage unit 120 through the same process as the existing method for searching contents when the search information that does not need to search the spatial/geographic contents 10 using the representative spatial information. In other words, the managing unit 180 detects the spatial/geographic contents 10 using the existing method for searching contents such as word search, producer search, etc. when the search information, which does not need to use the representative spatial information such as specific words, producers, etc. having no relation with the spatial information, is input.

The managing unit 180 manages (i.e., adds, deletes, changes, etc.) the spatial/geographic contents 10. In other words, the managing unit 180 classifies the spatial/geographic contents 10 input through the input unit 140 according to the type of contents and transmits them to the corresponding storage unit 120, thereby classifying the spatial/geographic contents 10 for each type and storing and managing them. To this end, the managing unit 180 sets the identifiers according to the type of contents of the spatial/geographic contents 10 in order to classify the spatial/geographic contents 10 for each type such as the satellite picture spatial information 19, the spatial web pages 12, the spatial pictures 14, the spatial moving pictures 16, the spatial sound 18, etc. and store and manage them. The managing unit 180 combines the identification code for classifying the type of the spatial/geographic contents 10 and the unique number for classifying each spatial/geographic content 10, thereby making it possible to set the identifiers of the spatial/geographic contents 10. For example, the managing unit 180 combines the identification codes formed of characters and the unique numbers formed of figures to set the identifiers of the spatial/geographic contents 10. In other words, the managing unit 180 sets the identification codes of the satellite picture spatial information 19 as “SE”, the identification codes of the spatial web pages 12 as “WE”, the identification codes of the spatial pictures 14 as “IM”, the identification codes of the spatial moving pictures 16 “MO”, and the identification codes of the spatial sound 18 as “SO”. The managing unit 180 sets the unique numbers having multiple digits that are sequentially increased for each type and combines them with the preset identification codes to set the identifiers of the spatial/geographic contents 10. The embodiment described the example where the managing unit 180 uses the identifiers formed of the identification codes and the unique numbers, but it is not limited thereto. Therefore, those skilled in the art can use the identifiers in various types.

The managing unit 180 can delete or change the spatial/geographic contents 10 stored in the storage unit 120 according to the manager request. Those skilled in the art can easily understand the contents where the managing unit 180 deletes or changes the spatial/geographic contents 10 and therefore, the detailed description thereof will be omitted.

To this end, as shown in FIG. 5, the managing unit 180 is configured to include a spatial information managing module 181 that manages the representative spatial information and the identifiers, the satellite picture spatial information managing module 183 that manages the satellite picture spatial information 19 and the identifier, a spatial web page managing module 185 that manages the spatial web pages 12 and the identifiers, a spatial picture managing module 187 that manages the spatial pictures 14 and the identifiers, and a spatial sound managing module 189 that manages the spatial sound 18 and the identifiers. The management means search, addition, deletion, change, etc.

For convenience of description, the embodiment describes the example where the functions of the apparatus for integrated management of spatial information are separated into each component (i.e., the storage unit 120, the input unit 140, the extracting unit 160, the managing unit 180), but it is not necessary limited to a separated state.

The embodiment shows the example where each component (i.e., the storage unit 120, the input unit 140, the extracting unit 160, and the managing unit 180) in the apparatus 100 for integrated management of spatial information is constituted and operated by one apparatus, but it is not limited thereto. Therefore, each component may be implemented as each independent apparatus and may process the corresponding functions. For example, as shown in FIG. 6, the extracting unit 160 is configured of the spatial information extracting apparatus 210, which is configured to include a web page spatial information extracting module 212, a picture spatial information extracting module 214, a moving picture spatial information extracting module 216, and a sound spatial information extracting module 218 all of which extract the representative spatial information according to the types of each spatial/geographic content 10. The managing unit 180 is configured to include a spatial information managing apparatus 220 that manages and processes the representative spatial information extracted according to the types of each content, a satellite information managing apparatus 230 that manages and processes the 2D or 3D satellite picture spatial information 19, a spatial web page managing apparatus 240 that manages and processes the web page documents, a spatial picture managing apparatus 250 that manages and processes the pictures (i.e., images and still pictures) and the moving pictures, and a spatial sound managing apparatus 260 that manages and processes sound. The storage unit 120 is configured to include a spatial information database 310 that associates the representative spatial information extracted according to the types of each content with the identifiers and stores them, a satellite information database 330 that stores the 2D or 3D satellite picture spatial information 19, a web page database 350 that stores the web page documents, a picture database 370 that stores the pictures (i.e., images and still pictures) and moving pictures, and a sound database 390 that stores sound. The spatial pictures 14 and the spatial moving pictures 16 that include the spatial images and the still pictures can be considered as a similar form and therefore, can be stored and managed through the spatial picture managing apparatus 250 and the picture database 370. Further, each apparatus that stores, manages, and processes each of the contents may be distributed and configured using the network connection.

As described above, the apparatus 100 for integrated management of spatial/geographic contents proposes the technology capable of viewing various types of contents including the spatial semantics from an integrated viewpoint to effectively integrate and manage various spatial/geographic contents 10, thereby making it possible to more effectively search the spatial/geographic contents 10 that are separately managed according to the types and are hard to search due to the correlation therebetween.

Further, the apparatus 100 for integrated management of spatial/geographic contents can expand the target and range of the existing general search services. For example, when generally searching the web pages including only the specific keywords, the pictures or the sound spatially associated with the web pages can be searched together.

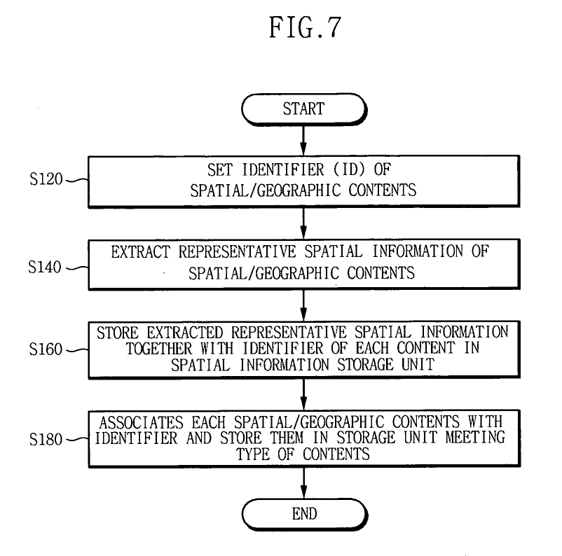

Hereinafter, the method for registering spatial/geographic contents according to the method for integrated management of spatial/geographic contents according to the embodiment of the present invention will be described below with reference to the accompanying drawings. FIG. 7 is a flow chart for explaining a method for registering spatial/geographic contents according to the method for integrated management of spatial/geographic contents according to the embodiment of the present invention.

The input unit 140 receives the spatial/geographic contents 10 added to the apparatus 100 for integrated management of spatial/geographic contents from the manager (or user). At this time, the input unit 140 receives the spatial/geographic contents 10 in various forms including the spatial information such as the satellite picture spatial information 19, the spatial web pages 12 (or documents), the spatial pictures 14 (that is, spatial images and spatial still pictures), the spatial moving pictures 16, the spatial sound 18, etc. The managing unit 180 sets the identifiers of the input spatial/geographic contents 10 (S120). At this time, the managing unit 180 sets the identifiers according to the types of the input spatial/geographic contents 10. In other words, the managing unit 180 sets the identifiers according to the type of contents of the spatial/geographic contents 10 in order to classify the spatial/geographic contents 10 for each type such as the satellite picture spatial information 19, the spatial web pages 12, the spatial pictures 14, the spatial moving pictures 16, the spatial sound 18, etc. and store and manage them. The managing unit 180 combines the identification codes that classifying the type of the spatial/geographic contents 10 and the unique numbers that classifying each spatial/geographic content 10, thereby setting the identifiers of the spatial/geographic contents 10.

The extracting unit 160 extracts the representative spatial information from the input spatial/geographic contents 10 (S140). At this time, the extracting unit 160 sets the representative spatial information of the corresponding spatial/geographic contents 10 based on the spatial information and geographical information of the keywords extracted from the spatial/geographic contents 10. Of course, the representative spatial information can be set by various methods according to the types of the spatial/geographic contents 10. The contents of extracting the representative spatial information from the spatial/geographic contents 10 in various forms will be described below with reference to the accompanying drawings.

The managing unit 180 associates the representative spatial information extracted from the extracting unit 160 with the set identifiers and stores them in the storage unit 120 (S160). In other words, the managing unit 180 associates the identifiers of the spatial/geographic contents 10 set at step S120 with the representative spatial information extracted as step S140 and stores them in the spatial information storage unit 129.

The managing unit 180 associates the spatial/geographic contents 10 with the identifiers and stores them in the storage unit 120 (S180). The managing unit 180 associates the spatial/geographic contents 10 with the identifiers set at step S120 and stores them in the storage unit 120. At this time, the managing unit 180 stores them in the corresponding storage unit 120 according to the types of the spatial/geographic contents 10. For example, the managing unit 180 stores the spatial/geographic contents 10 in the spatial web pages 12 or the documents in the web page storage unit 123 and stores the spatial/geographic contents 10 such as the images, the still pictures, the moving pictures, etc. in the spatial picture 14 form and the spatial moving picture 16 form in the picture storage unit 125, and stores the spatial/geographic contents 10 in the spatial sound 18 form in the sound storage unit 127. At this time, the managing unit 180 includes the separate storage unit 120 for efficiency of specific situations to integrate and store the spatial/geographic contents independently of the types of the corresponding spatial/geographic contents 10.

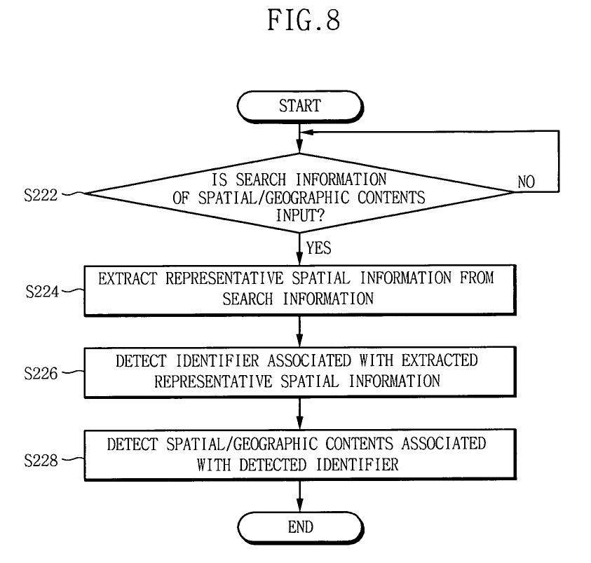

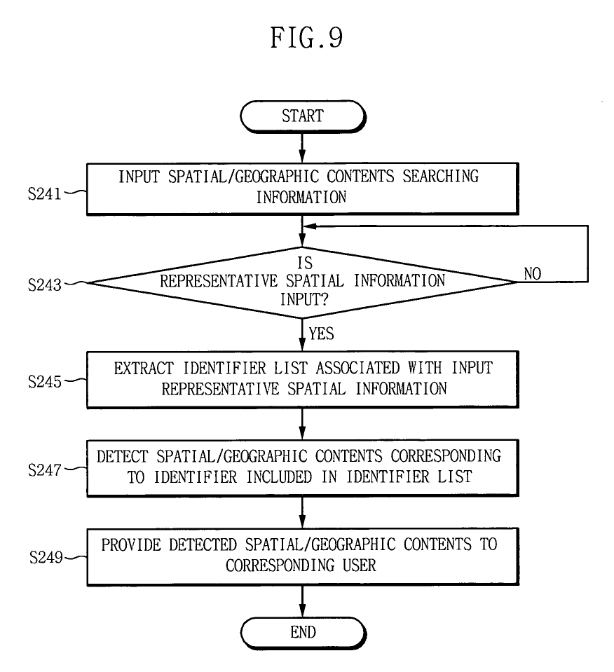

Hereinafter, a method of searching spatial/geographic contents according to a method for integrated management of spatial/geographic contents according to an embodiment of the present invention will be described in detail with reference to the accompanying drawings. FIGS. 8 and 9 are flow charts for explaining a method of searching spatial/geographic contents according to a method for integrated management of spatial/geographic contents according to the embodiment of the present invention.

The input unit 140 receives search information for searching the spatial/geographic contents 10 from the user (S222). At this time, the search information input from the user has a type that the representative spatial information is not used at the time of searching the spatial/geographic contents 10, a type that the representative spatial information for searching the spatial/geographic contents 10 or the range of the representative spatial information is explicitly given in the search information, and a type that the representative spatial information for searching the spatial/geographic contents 10 or the range of the representative spatial information is not explicitly given in the search information. The description of each type is defined in the description of the above-mentioned terms and therefore, the detailed description thereof will be omitted.

When the spatial/geographic contents 10 are input in the search information (S222; YES), the extracting unit 160 extracts the representative spatial information from the input search information (S224). In other words, the extracting unit 160 extracts the representative spatial information from the search information input in a query form from the user in order to search the spatial/geographic contents 10. At this time, the extracting unit 160 cannot perform the extraction of the representative spatial information according to the type of search information. In other words, although the representative spatial information is described in the search information, the extracting unit 160 does not extract the representative spatial information from the search information when the search information does not use the representative spatial information at the time of searching the spatial/geographic contents 10.

The managing unit 180 detects the identifiers associated with the extracted representative spatial information from the storage unit 120 (S226). In other words, the managing unit 180 detects the identifiers associated with the representative spatial information extracted at step S224 from the spatial information storage unit 129. The managing unit 180 can detect the identifiers of the contents meeting the given conditions together with the search information from the storage unit of the corresponding contents when the representative spatial information is not explicitly given in the input search information (that is, when the representative spatial information should be known from the query through the process).

At this time, the managing unit 180 searches the spatial information storage unit 129 with the representative spatial information detected from the search information to detect the identifiers of the spatial/geographic contents 10 associated with the given area (that is, representative spatial information) to generate the identifier list, when the representative spatial information is explicitly given in the input search information or when the representative spatial information may be estimated without performing the special process (for example, when searching all the representative spatial information, etc.). The managing unit 180 may not perform the detection of the identifiers when the representative spatial information is not extracted at step S224.

The managing unit 180 detects the spatial/geographic contents 10 associated with the detected identifier from the storage unit 120 (S228). The managing unit 180 detects the spatial/geographic contents 10 associated with the identifiers detected at step S226 from each storage unit 120 (that is, the satellite information storage unit 121, the web page storage unit 123, the picture storage unit 125, the sound storage unit 127) storing the spatial/geographic contents 10. In other words, the managing unit 180 transfers the identifiers included in the identifier list to the related storage unit 120 (that is, the satellite information storage unit 121, the web page storage unit 123, the picture storage unit 125, the sound storage unit 127) and detects the spatial/geographic contents 10 corresponding thereto. The managing unit 180 provides the detected spatial/geographic contents 10 to the user.

The managing unit 180 may transfer the search information to the corresponding contents storage unit 120 according to the type of contents to be searched to obtain the results and then provide them to the user when the input search information can be processed independently from the representative spatial information.

Of course, when the representative spatial information is not explicitly given in the input search information (that is, when the representative spatial information should be known from the query through the process), the managing unit 180 obtains the identifiers which correspond to a given condition with the search information from the storage unit 120 which stored the corresponding contents. And the managing unit 180 obtains the representative spatial information of the contents meeting the given conditions by searching the spatial information storage unit 129 using the identifiers. Thereafter, the managing unit detects the associated representative spatial information to obtain the identifiers of the corresponding contents, transfers the contents identifiers to the proper storage unit 120 according to the types to obtain the spatial/geographic contents 10 to be obtained by the query, and can the results to the user (manager).

Hereinafter, the method for searching representative spatial information according to the method for integrated management of spatial/geographic contents according to an embodiment of the present invention will be described in detail with reference to the accompanying drawings.

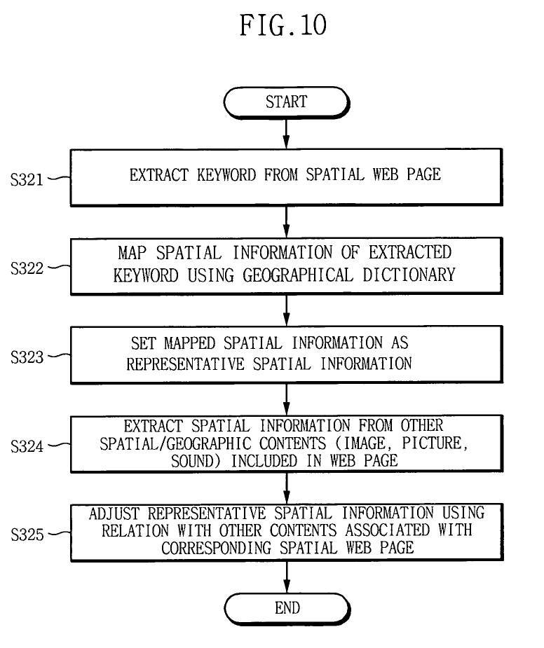

FIGS. 10 to 12 are flow charts for explaining the method for extracting representative spatial information from the spatial web pages.

In FIG. 10, when the representative spatial information of the spatial web pages 12 (or documents) means the spatial and geographical range of the contents including the web pages, the method for extracting the representative spatial information from the spatial web pages will be described.

First, the extracting unit 160 extracts the keywords included in the spatial web pages 12 by analyzing the contents of the web pages (S321).

The extracting unit 160 maps the spatial information (that is, spatial semantics and location) of the extracted keywords by searching a geographical dictionary (S322).

At this time, the extracting unit 160 sets the mapped spatial information as the representative spatial information of the corresponding spatial web pages 12 in the keywords (S323). Since several keywords may be included in one document, the spatial and geographical range associated with these keywords may be represented by the spatial location in various forms such as a point, a line, a surface, etc. Further, since the web pages (or documents) may include images or sound, the extracting unit 160 extracts the representative spatial information by using the method for extracting representative spatial information of the spatial pictures 14 and the spatial sound 18 to be described below.

The extracting unit 160 refers the correlation (for example, mutual link information, etc.) between several web pages when extracting the representative spatial information from the web page to adjust the representative spatial information of the extracted one web page (S325). Various detailed methods and algorithms can be selectively used according to circumstances in order to extract the keyword from the web pages (documents) during the extracting process of the representative spatial information, map the keywords using the geographical dictionary, etc. with the spatial and geographical locations, adjust the representative spatial information of each document considering the relation between several web pages (documents), etc.

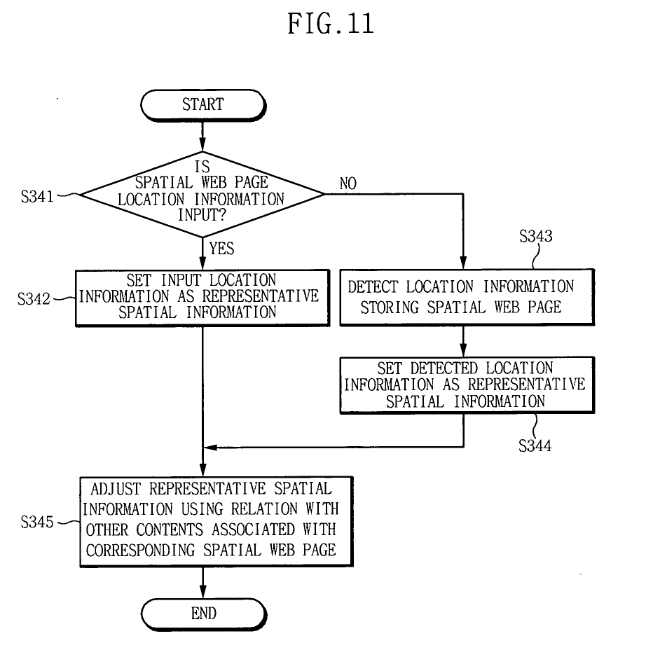

In FIG. 11, when the representative spatial information of the spatial web pages 12 (or documents) means the geographical and physical locations storing the corresponding contents, the method for extracting the representative spatial information from the spatial web pages will be described.

First, when the location information on the spatial web pages 12 is input through the input unit 140 from the user (S341; YES), the extracting unit 160 sets the location information input to the input unit 140 as the representative spatial information of the corresponding spatial web pages 12 (S342). At this time, the input unit 140 receives the location storing the corresponding spatial web pages 12 as the location information from the user.

The extracting unit 160 detects the location information of the apparatus storing the corresponding spatial web pages 12 (that is, the web page storage unit 123, the web page database, etc.) when the location information is not input through the input unit 140 (S343).

The extracting unit 160 sets the detected location information as the representative spatial information of the corresponding spatial web pages 12 (S344). In other words, the extracting unit 160 sets the input location information or the detected location information as the representative spatial information of the corresponding spatial web pages 12.

The extracting unit 160 refers the correlation (for example, mutual link information, etc.) between several web pages to adjust the representative spatial information of the set one web page (S345). Various methods and algorithms can be selectively used according to circumstances in order to extract the keyword from the web pages (documents) during the extracting process of the representative spatial information, map the keywords using the geographical dictionary, etc. with the spatial and geographical positions, adjust the representative spatial information of each document considering the relation between several web pages (documents), etc.

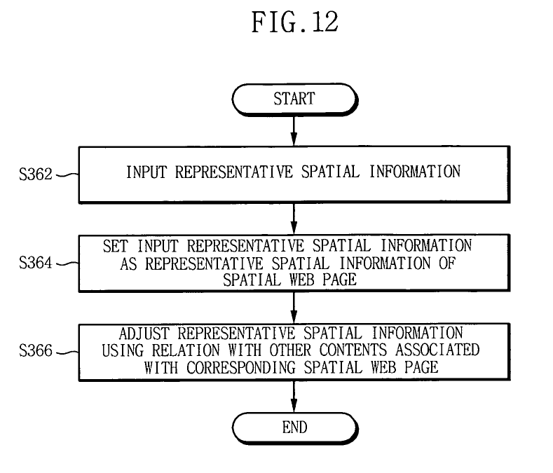

In FIG. 12, when the representative spatial information of the spatial web pages 12 means attributes (for example, it may be attribute information including locations at which the contents are produced or obtained or special semantics provided by other users) designated by the user, a method for detecting representative spatial information from the spatial web pages 12 will be described.

The input unit 140 receives the representative spatial information (that is, attribute information) from the user (S362). That is, the input unit 140 receives the user designated attribute information such as the locations at which the contents are produced and obtained in the spatial web pages 12.

The extracting unit 160 sets the input representative spatial information as the representative spatial information of the corresponding spatial web pages 12 (S364). In other words, the extracting unit 160 sets the attribute information input by the user as the representative spatial information of the spatial web pages 12.

The extracting unit 160 adjusts the representative spatial information by using the relation between the corresponding web pages and other contents (S366). Various methods and algorithms can be selectively used according to circumstances in order to extract the keyword from the web pages (documents) during the extracting process of the representative spatial information, map the keywords using the geographical dictionary, etc. with the spatial and geographical positions, adjust the representative spatial information of each document considering the relation between several web pages (documents), etc.

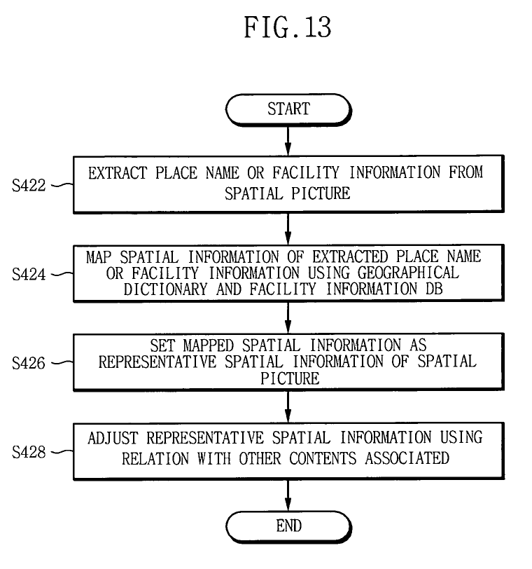

FIGS. 13 to 15 are flow charts for explaining the method for detecting representative spatial information from the spatial pictures.

In FIG. 13, when the representative spatial information of the spatial pictures 14 (that is, still pictures and images) means the spatial and geographical range of the contents including the still pictures and images, the method for detecting representative spatial information from the spatial web pages 12 will be described below.

First, the extracting unit 160 extracts objects (that is, place name, facility information, etc.) capable of estimating the spatial information from the spatial picture 14 (S422). At this time, the extracting unit 160 extracts natural objects and facility objects including images and words (for example, a sign post, a direction board, etc.) through various image processing techniques.

The extracting unit 160 matches the spatial information with the extracted objects by using the geographical dictionary and the facility information database (S424). In other words, the extracting unit 160 detects and maps the spatial information including the spatial semantics and locations of the corresponding objects from the existing object database including the extracted objects and the geographical dictionary.

The extracting unit 160 sets the matched spatial information as the representative spatial information of the corresponding spatial web pages 14 (S426). In other words, the extracting unit 160 sets the spatial semantics and locations mapped to the detected objects as the representative spatial information of the corresponding spatial pictures 14.

Similar to the case of the spatial web page 12, since the objects included in one spatial picture 14 (that is, images, still pictures) may exist in plural, the spatial and geographical range associated with these objects may be represented by the spatial positions in various forms such a point, a line, a surface, etc. As a result, when the representative spatial information of one still picture and image is extracted, the representative spatial information of the extracted spatial pictures 14 is adjusted by referring the correlation (for example, continuously photographed images or sequence of images) between several still pictures and images (S428). Various detailed methods and algorithms, etc. can be selectively used according to circumferences in order to adjust the representative spatial information of each spatial picture 14 considering the correlation between the spatial pictures 14 and several images and still pictures during the extracting process of the representative spatial information.

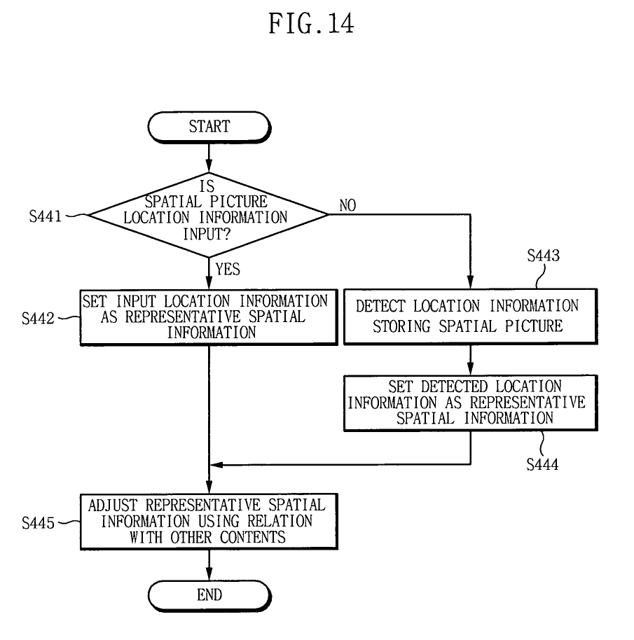

In FIG. 14, when the representative spatial information of the spatial pictures 14 (that is, still pictures and images) means the geographical and physical positions storing the corresponding contents, the method for detecting representative spatial information from the spatial web pages 14 will be described below.

First, when the location information on the spatial pictures 14 is input through the input unit 140 by the user (S441; YES), the extracting unit 160 sets the location information input to the input unit 140 as the representative spatial information of the corresponding spatial pictures 14 (S442). At this time, the input unit 140 receives from the user the location where the corresponding spatial pictures 14 is stored as the location information from the user.

The extracting unit 160 detects the location information of the apparatus (that is, the picture storage unit 125, the picture database, etc.) storing the corresponding spatial pictures 14 when the location information is not input through the input unit 140 (S443).

The extracting unit 160 sets the detected position information as the representative spatial information of the corresponding spatial pictures 14 (S444). In other words, the extracting unit 160 sets the input location information or the detected location information as the representative spatial information of the corresponding spatial pictures 14.

The extracting unit 160 adjusts the representative spatial information of the set spatial pictures 14 by referring the correlation between several images and still pictures (S445). Various detailed methods and algorithms, etc. can be selectively used according to circumferences in order to adjust the representative spatial information of each spatial picture 14 considering the correlation between the spatial pictures 14 and several images and still pictures during the extracting process of the representative spatial information.

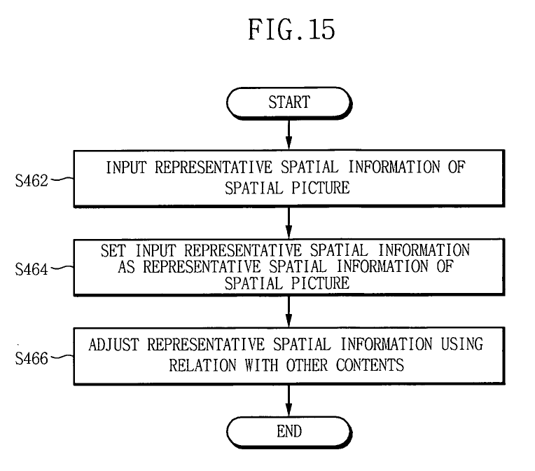

In FIG. 15, when the representative spatial information of the spatial pictures 14 (that is, still pictures and images) means the user designated attributes, the method for detecting representative spatial information from the spatial pictures 14 will be described below.

The input unit 140 receives the representative spatial information (that is, attribute information) from the user (S462). That is, the input unit 140 receives the user designated attribute information such as the locations at which the spatial pictures are produced and obtained, etc., from the user.

The extracting unit 160 sets the input representative spatial information as the representative spatial information of the corresponding spatial pictures 14 (S464). In other words, the extracting unit 160 sets the attribute information input by the user as the representative spatial information of the corresponding spatial pictures 14.

The extracting unit 160 adjusts the representative spatial information by using the relation between the corresponding spatial pictures 14 and other contents (S466). Various detailed methods and algorithms, etc. can be selectively used according to circumferences in order to adjust the representative spatial information of each spatial picture 14 considering the correlation between the spatial pictures 14 and several images and still pictures during the extracting process of the representative spatial information.

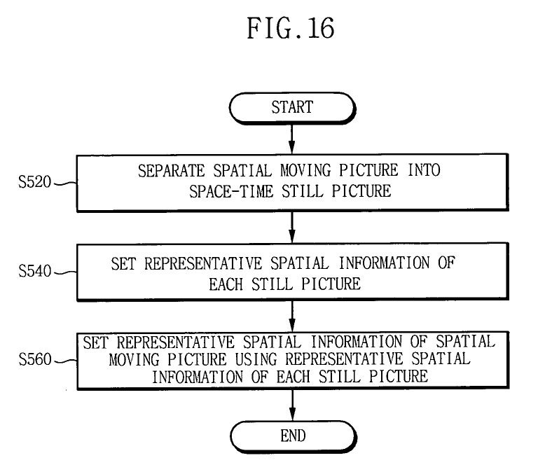

FIG. 16 is a flow chart for explaining a method for detecting representative spatial information from the spatial moving pictures. In the case of the spatial moving pictures 16 that is one of the spatial/geographic contents 10, the moving pictures can be generally considered as sequence of several still pictures and images, such that they uses the method for extracting representative spatial information from the spatial pictures 14 described above.

The extracting unit 160 separates the spatial moving pictures 16 into space-time still pictures (S520). In other words, the extracting unit 160 separates the spatial moving pictures 16 into the plurality of spatial pictures 14 (that is, still pictures or images).

The extracting unit 160 sets the representative spatial information of each of the plurality of separated spatial pictures 14 (S540). At this time, the extracting unit 160 extracts the representative spatial information of each spatial picture 14 by the method for extracting representative spatial information (that is, FIGS. 13 to 15) of the above-mentioned spatial pictures 14.

The extracting unit 160 sets the representative spatial information of the spatial moving pictures 16 by using the representative spatial information of each spatial picture 14 (S560). That is, the extracting unit 160 combines and abstracts the representative spatial information extracted from each spatial picture 14 and finally, sets the representative spatial information on the spatial moving pictures 16.

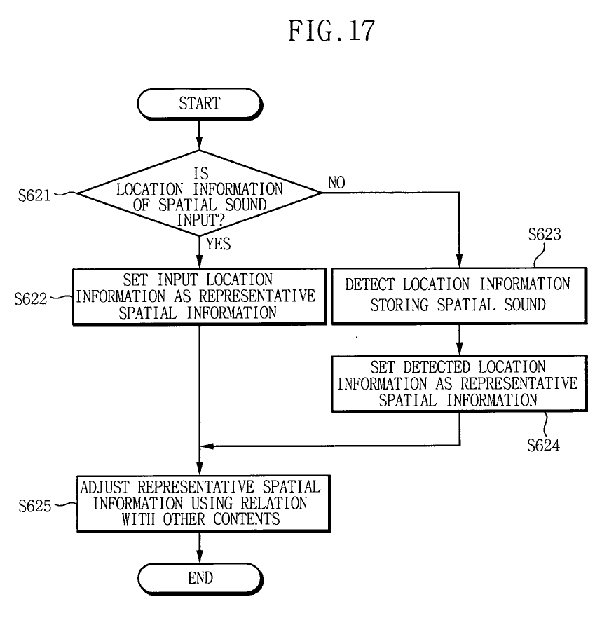

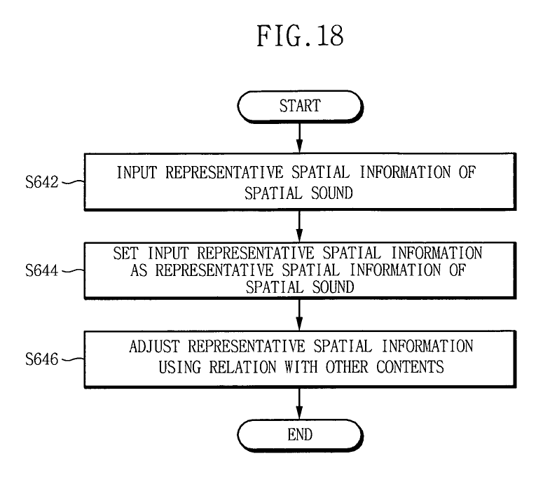

FIGS. 17 and 18 are flow charts for explaining the method for detecting representative spatial information from the spatial sound. In the case of the spatial sound 18, since it is impossible to give the spatial semantics of the sound by analyzing the sound, the representative spatial information of the spatial sound 18 may be the geographical and physical locations storing the corresponding contents or the user designated attribute information (for example, recording location, etc.). Therefore, in the case of the spatial sound 18, there are roughly about two kinds of method for extracting representative spatial information.

In FIG. 17, when the representative spatial information of the spatial pictures 18 means the geographical and physical positions storing the corresponding contents, the method for detecting representative spatial information from the spatial sound 18 will be described below.

First, when the location information on the spatial sound 18 is input through the input unit 140 from the user (S621; YES), the extracting unit 160 sets the location information input to the input unit 140 as the representative spatial information of the corresponding spatial sound 18 (S622). At this time, the input unit 140 receives the location storing the corresponding spatial sound 18 as the location information from the user.

The extracting unit 160 detects the location information of the apparatus (that is, the sound storage unit 127, the sound database, etc.) storing the corresponding spatial sound 18 when the location information is not input through the input unit 140 (S623).

The extracting unit 160 sets the detected position information as the representative spatial information of the corresponding spatial sound 18 (S624). In other words, the extracting unit 160 sets the input location information or the detected location information as the representative spatial information of the corresponding spatial sound 18.

The extracting unit 160 adjusts the representative spatial information of the set spatial sound 18 by referring the correlation between several spatial sound 18 (S625). Various detailed methods and algorithms, etc. can be selectively used according to circumferences in order to adjust the representative spatial information of each spatial sound 18 considering the correlation between the spatial sound 18 and other several sounds 18 during the extracting process of the representative spatial information.

In FIG. 18, when the representative spatial information of the spatial sound 18 means the user designated attributes, the method for detecting representative spatial information from the spatial sound 18 will be described below.

The input unit 140 receives the representative spatial information (that is, attribute information) from the user (S642). That is, the input unit 140 receives the user designated attribute information such as the locations at which the spatial sound 18 is produced and obtained, etc., from the user.

The extracting unit 160 sets the input representative spatial information as the representative spatial information of the corresponding spatial sound 18 (S644). In other words, the extracting unit 160 sets the attribute information input by the user as the representative spatial information of the corresponding spatial sound 18.

The extracting unit 160 adjusts the representative spatial information by using the relation between the corresponding spatial sound and other contents (S646). Various detailed methods and algorithms, etc. can be selectively used according to circumferences in order to adjust the representative spatial information of each spatial sound 18 considering the correlation between the spatial sound 18 and several spatial sounds 18 during the extracting process of the representative spatial information.

As described above, the method for integrated management of spatial/geographic contents proposes the technology capable of viewing various types of contents including the spatial semantics from an integrated viewpoint to effectively integrate and manage various spatial/geographic contents 10, thereby making it possible to more effectively search the spatial/geographic contents 10 that are separately managed according to the type and are hard to search due to the correlation there between.

Further, the method for integrated management of spatial/geographic contents can expand the target and range of the existing general search services. For example, at the time of searching the web page including only the specific keywords, the pictures or sounds which are spatially associated with the web pages can be searched together.

Although preferred embodiments of the present invention have been described, it will be appreciated by those skilled in the art that various modifications and changes may be made without departing from the appended claims of the present invention.

What is claimed is:

1. An apparatus for integrated management of spatial/geographic contents, comprising:
a storage unit that divides and stores a plurality of spatial/geographic contents according to types of contents and then stores identifiers and representative spatial information of each of the plurality of spatial/geographic contents;
an extracting unit that extracts the representative spatial information from input search information and the spatial/geographic contents; and
a managing unit that detects identifiers corresponding to the representative spatial information extracted from the search information in the extracting unit from the storage unit and detects the spatial/geographic contents corresponding to the detected identifiers from the storage unit.

2. The apparatus for integrated management of spatial/geographic contents according to claim 1, wherein the managing unit sets the identifiers according to the types of the spatial/geographic contents.

3. The apparatus for integrated management of spatial/geographic contents according to claim 2, wherein the storage unit associates the spatial/geographic contents with the identifiers set in the managing unit and stores them.

4. The apparatus for integrated management of spatial/geographic contents according to claim 2, wherein the storage unit associates the representative spatial information extracted from the spatial/geographic contents in the extracting unit with the identifiers set in the spatial/geographic contents in the managing unit and stores them.

5. The apparatus for integrated management of spatial/geographic contents according to claim 1, wherein the storage unit includes:
a satellite information storage unit that stores the satellite picture spatial information;
a web page storage unit that stores spatial web pages;
a picture storage unit that stores spatial pictures and spatial moving pictures;
a sound storage unit that stores spatial sound; and
a spatial information storage unit that associates the identifiers and representative spatial information of the spatial/geographic contents and stores them.

6. The apparatus for integrated management of spatial/geographic contents according to claim 1, wherein the extracting unit sets the representative spatial/geographic information of the corresponding spatial/geographic contents based on the spatial information and the geographical information of keywards extracted from the spatial/geographic contents.

7. The apparatus for integrated management of spatial/geographic contents according to claim 1, wherein the extracting unit sets the storage location of the spatial/geographic contents as the representative spatial information of the spatial/geographic contents.

8. The apparatus for integrated management of spatial/geographic contents according to claim 1, wherein the extracting unit includes:
a web page spatial information extracting module that extracts the representative spatial information from spatial web pages;
a picture spatial information extracting module that extracts the representative spatial information from spatial pictures;
a moving picture spatial information extracting module that extracts the representative spatial information from spatial moving picture file; and
a sound spatial information extracting module that extracts the representative spatial information from spatial sound files.

9. The apparatus for integrated management of spatial/geographic contents according to claim 1, further comprising an input unit that receives at least one of the search information and the spatial/geographic contents.

10. The apparatus for integrated management of spatial/geographic contents according to claim 9, wherein the managing unit detects the identifiers corresponding to the representative spatial information included in the search information from the storage unit unit when the search information including the representative spatial information of the spatial/geographic contents is input through the input unit.

11. The apparatus for integrated management of spatial/geographic contents according to claim 9, wherein the managing unit detects the spatial/geographic contents corresponding to the identifiers included in the search information from the storage unit when the search information including the identifiers of the spatial/geographic contents is input.

12. A method for integrated management of spatial/geographic contents, comprising:
setting identifiers of spatial/geographic contents by a managing unit;
extracting representative spatial information from the spatial/geographic contents by an extracting unit;
spatial information storing that associates the identifiers of the spatial/geographic contents set at the setting step with the representative spatial information of the spatial/geographic contents extracted at the extracting step by the managing unit and stores them in the storage unit; and
contents storing that associates the identifiers set at the setting step with the spatial/geographic contents by the managing unit and stores them in the storage unit.

13. The method for integrated management of spatial/geographic contents according to claim 12, wherein the setting sets the identifiers according to the type of the spatial/geographic contents by the managing unit.

14. The method for integrated management of spatial/geographic contents according to claim 12, wherein the contents storing classifies the contents for the types of contents by the managing unit and stores spatial/geographic contents in the storage unit.

15. The method for integrated management of spatial/geographic contents according to claim 12, wherein the extracting sets the representative spatial information of the corresponding spatial/geographic contents based on the spatial information and the geographical information of the keywords extracted from the spatial/geographic contents by the extracting unit.

16. The method for integrated management of spatial/geographic contents according to claim 12, further comprising receiving the spatial/geographic contents by the input unit.

17. A method for integrated management of spatial/geographic contents, comprising:
extracting representative spatial information from input search information by an extracting unit;
identifier detecting that detects identifiers corresponding to the representative spatial information extracted in the extracting step from the storage unit, by the managing unit; and
contents detecting that detects the spatial/geographic contents corresponding to the identifiers detected in the identifier detecting step from the storage unit, by the managing unit.

18. The method for integrated management of spatial/geographic contents according to claim 17, further comprising inputting the search information for searching the contents from a user by the input unit.

19. The method for integrated management of spatial/geographic contents according to claim 18, wherein the identifier detecting detects the identifiers corresponding to the representative spatial information included in the search information from the storage unit when the search information including the representative spatial information of the spatial/geographic contents is input at the inputting step.

20. The method for integrated management of spatial/geographic contents according to claim 18, wherein the contents detecting detects the spatial/geographic contents corresponding to the identifiers included in the search information from the storage unit by the managing unit when the search information including the identifiers of the spatial/geographic contents is input at the inputting step.
